(19) United States
(12) Patent Application Publication
(10) Pub. No.: US 2004/0223462 A1
(43) Pub. Date: Nov. 11, 2004

(54) Auto negotiate extension for ethernet infrastructure

(75) Inventors: Daryl Carvis Cromer, Apex, NC (US); Howard Jeffrey Locker, Cary, NC (US); Marc Richard Pamley, Durham, NC (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/434,822

(22) Filed: May 9, 2003

(51) Int. Cl. H04L 12/26

(52) U.S. Cl. 370/252

(57) ABSTRACT

An Ethernet auto-negotiate extension incorporates a gigabit verification procedure following the establishment of a gigabit level of serve. If auto-negotiate resolves a gigabit data rate for a particular connection, the auto-negotiate extension verifies that each of the eight required wires is functional. The verification extension sends a data pattern that can by detected only if all eight wires are functional. In this manner, the ability of each wire to transition between 1's and 0's at the highest possible data rate is verified. The gigabit verification extension will detect flag any wires that are missing, grounded from a previous 10 or 100 Mbps system or otherwise non-functional. By incorporating this functional verification extension, the invention recognizes the limited functional verification inherent in auto-negotiate. The invention leaves the core pieces of the auto-negotiate process intact thereby minimizing the impact on existing systems.

### BACKGROUND

1. Field of the Present Invention

The present invention generally relates to the field of data processing networks and more particularly to Ethernet networks employing twisted pair cabling.

2. History of Related Art

In the field of data processing local area networks (LANs), the transition from 10/100 Megabits/second (Mbps) systems to 1000 Mbps (Gigabit) systems is ongoing. The installed base of 10/100 Ethernet systems was largely implemented with Category 5 (CAT 5), twisted pair cabling as specified by ANSI/EIA (American National Standards Institute/Electronic Industries Association) Standard 568. Standard 568 specifies the cable material as well as the type of connectors and junction blocks to be used in order to guarantee the data rate associated with the category. Originally, 100 Mbps Ethernet systems used 4 twisted wire pairs (8 wires) of which 4 wires were terminated to ground. More recently, 100 Mbps Ethernet implementations employ improved drivers that eliminate the need for the 4 ground wires. Gigabit Ethernet can also operate on CAT 5 systems having 4 twisted-pairs although all 8 wires are needed. Thus, at the physical layer, there is substantially no difference between Gigabit Ethernet systems employing CAT 5 cabling and many 100 Mbps systems. On the other hand, other 10 and 100 Mbps implementations that ground or simply eliminate one or more of the four “spares” cannot support gigabit operation.

Ethernet uses an automated negotiation (auto-negotiate) procedure to establish the maximum sustainable data rate between any two devices when the connection is established. Regardless of the data rate, this procedure uses only four wires. The auto-negotiate procedure allows each device to send a command (Fast Link Pulse) indicating the fastest data rate supported. Both devices will configure at the fastest data rate both devices can support. Trouble can arise when auto-negotiate (using just four of the wires) negotiates a gigabit data rate over a connection that does not have eight available wires. It would be desirable to implement an extension to auto-negotiate that addresses this potential problem. It would be further desirable if the implemented solution did not mandate significant changes to existing implementation and did not significantly increase the cost of complexity of the network media.

### SUMMARY OF THE INVENTION

The problems identified above are addressed according to the present invention with an auto-negotiate extension that incorporates a gigabit verification procedure. If auto-negotiate resolves a gigabit data rate for a particular connection, the auto-negotiate extension then verifies that each of the eight required wires is functional at gigabit speeds. The verification extension sends a data pattern that can by detected only if all eight wires are functional. In one embodiment, a sequence of alternating 1's and 0's are transmitted over the media as part of the gigabit verification extension. In this manner, the ability of each wire to transition between 1's and 0's at the highest possible data rate is verified. The gigabit verification extension will detect any wires that are missing, grounded from a previous 10 or 100 Mbps system or otherwise non-functional. By incorporating this functional verification extension, the invention beneficially recognizes the limited functional verification inherent in auto-negotiate. Moreover, the invention leaves the core pieces of the auto-negotiate process intact thereby minimizing the impact on existing systems.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a network according to one embodiment of the present invention;

FIG. 2 is a block diagram of selected elements of a network interface card suitable for use in the network of FIG. 1;

FIG. 3 is a diagram of selected elements of a network according to one embodiment of the invention;

FIG. 4 is a conceptual depiction of a table suitable for use in a NIC employing logical signal re-routing according to one embodiment of the invention;

FIG. 5 is a flow diagram of a method of configuring a network media according to one embodiment of the invention; and

FIG. 6 is a flow diagram of a method of verifying functionality following establishment of a gigabit level of service.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates improved automation in Ethernet LAN's by extending the auto-negotiate process to include a gigabit functional verification when the auto-negotiate process negotiates a gigabit data rate for a particular connection. If the gigabit functional verification does not pass, it is assumed that one or more of the four traditional “spare” wires in 10 and 100 Mbps implementations are non-functional. The auto-negotiate extension automatically handles this problem by resolving a lower priority data rate for the connection, where the resolved data rate only requires the four wires over which the auto-negotiate was performed.

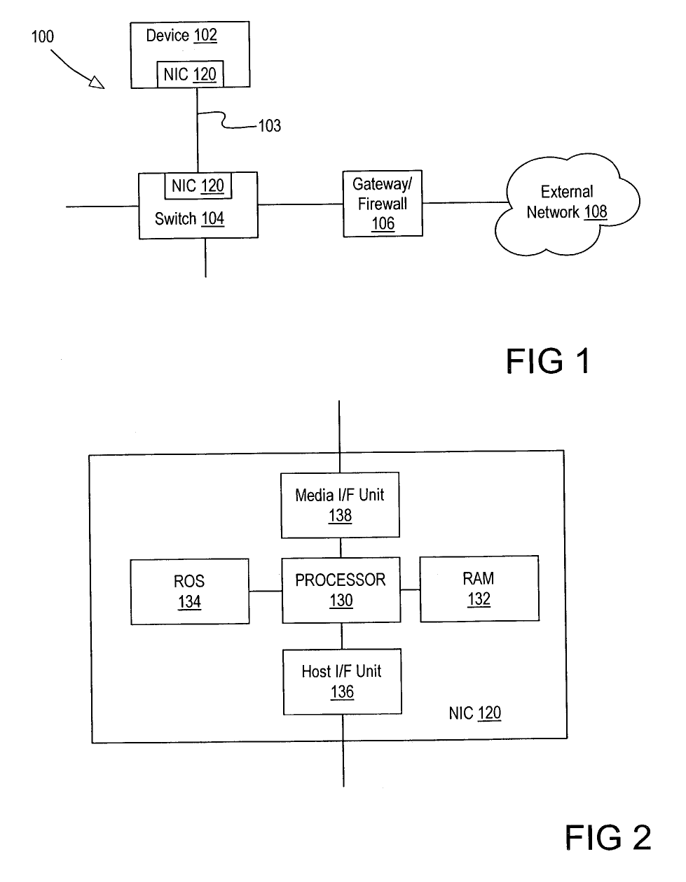

Turning now to the drawings, FIG. 1 is a simplified block diagram of selected components of the data processing network 100 according to one embodiment of the present invention. In the depicted embodiment, network 100 is an example of a LAN in which one or more data processing devices 102 are connected to a switch 104. Data processing device 102 may include servers, storage devices, desktop machines, network computers, data terminals, and the like. Switch 104 may comprise a router or the like to which multiple devices 102 are connected.

Network 100 employs a physical medium 103 to connect device(s) 102 to switch 104. In the preferred embodiment of the invention, physical medium 103 includes 4-pair (8 wire) CAT 5 cabling suitable for use in 10, 100, and 1000 Mbps Ethernet systems as specified in IEEE 802.3. Such systems include 10BaseT4, 100BaseT4, and Gigabit Ethernet systems.

The depicted embodiment of network 100 includes a gateway and firewall unit 106 connected to switch 104. Unit 106 is suitable for connecting network 100 to an external network 108 such as the Internet. Although unit 106 is illustrated as a single unit, it will be appreciated that unit 106 may include two or more physically distinct devices.

Device 102 and switch 104 are both depicted as including a network interface device (referred to herein as a NIC) 120. NIC 120 may be implemented as an adapter card that connects to a processing board or motherboard. Alternatively, NIC 120 may be integrated onto the motherboard or integrated within a processor itself. NIC 120 is configured to enable a processor on the corresponding device to communicate with external devices over the physical medium 103.

Referring now to FIG. 2, selected elements of a NIC 120 are shown to emphasize features of the present invention. NIC 120 is suitable for use as the network interface for device 102 and switch 104. Although the network interface for device 102 and switch 104 may have unique elements, the elements depicted in FIG. 2 are common to each and are sufficient to enable NIC 120 to communicate information between the host (device 102 or switch 104) in accordance with the teachings of the present invention. NIC 120 includes hardware, software, or a combination of the two, that enables the NIC to convert digital information to a set of signals suitable for transmission over medium 103.

In the depicted embodiment, NIC 120 includes a processor 130, random access memory (RAM) 132, Read-only storage (ROS) 134, a host interface unit (HIFU) 136, and a media interface unit (MIFU) 138. Processor 130 is likely implemented with an embedded controller such as a Series 403 PowerPC® embedded controller from IBM Corporation. Alternatively, processor 130 could be implemented with a general purpose CISC or RISC processor or DSP processor. It is also possible that NIC 120 could be embedded within a single chip that integrates any or all of processor 130, RAM 132, ROS 134, HIFU 136, and MIFU 138. RAM 132 is connected to processor 130 and provides a scratch memory area for the processor. ROS 134 is typically programmed or manufactured to store one or more sequences of instructions executable by processor 130. The HIFU 136 typically includes buffers and associated logic that enables NIC 120 to communicate with its host, whether it is device 102, switch 104, or another host.

The depicted embodiment of MIFU 138 is configured to receive digital information provided by processor 130 and to convert or format the corresponding information for transmission over the network media 103. In an Ethernet embodiment of network 100, the physical layer includes various sublayers that are implemented within NIC 120 and MIFU 138. Eight bit data chunks referred to as frames are transmitted from a media access control (MAC) layer, to a physical coding sublayer (PCS) through a Gigabit Media Independent Interface (GMII). MIFU 138 converts the information received from the GMII into signals suitable for transmission over media 103. In one implementation for Gigabit Ethernet, MIFU 138 employs four-dimensional Pulse Amplitude Modulation 5 (4D-PAM-5) encoding. The fundamental difference in the operation of 10/100 Mbps Ethernet and Gigabit Ethernet is that Gigabit operation uses all four twisted pairs, transmitting and receiving simultaneously on all four pairs where 10/100 Mbps uses only two pairs, one dedicated for transmitting and one dedicated for receiving. 4D-PAM-5 encoding resolves each of the media wires into one of five voltage levels (−1.0V, −0.5V, 0V, 0.5V, and 1.0V) enabling the encoding of a large number of signals. In a Gigabit Ethernet configuration (four wire pairs), PAM 5 encoding enables the generation of 5⁴ or 625 potential codes, which is more than sufficient to encode 8-bit frames.

In one embodiment, processor 130 generates processor signals that are provided to the wires in media 103 through the intervening MIFU 138. The signals produced on media 103 reflect the correspondence between the processor signals, the signals output from MIFU 138, and physical media signal wires. If a device 102 within the system determines that its connection is non-functional, NIC 120 may logically re-route its outputs by altering the correspondence between the processor signals and physical media wires. If NIC 120 is able to find a minimum number of functional signal wires in media 103, NIC 120 may reroute the signals it produces to the functional signal wires thereby enabling the system to continue operation, even if at a reduced data rate. This feature of NIC 120 is the subject of a U.S. patent application entitled Dynamic Cable Assignment on Gigabit Infrastructure, filed 17 DEC. 2002, which is commonly assigned with the present application.

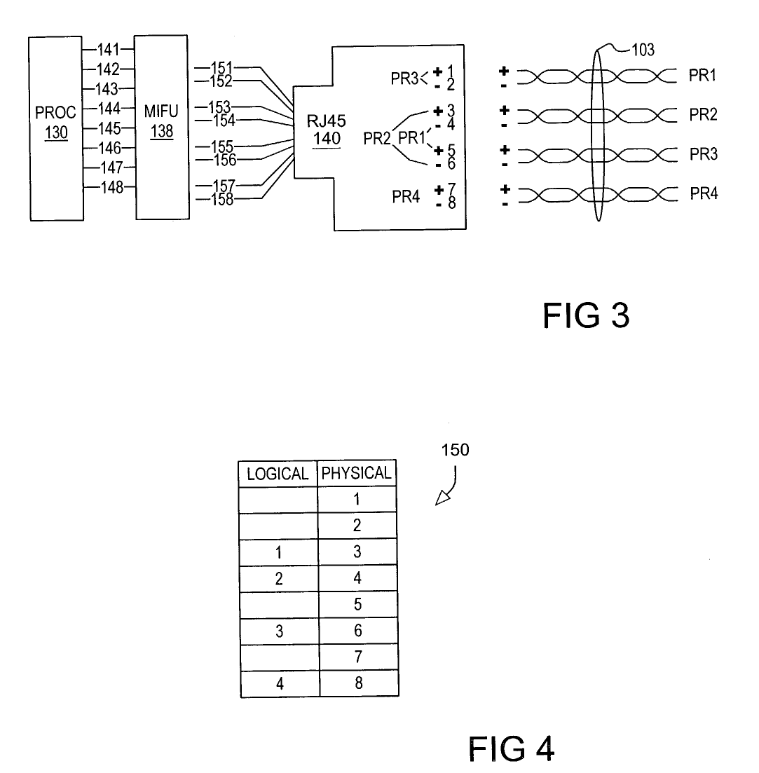

Referring now to FIG. 3 and FIG. 4, selected elements of the network 100 are shown to emphasize aspects of the invention. In the illustration, network media 103 is shown as including 8 wires configured as 4 twisted pairs identified as PR 1, PR 2, PR 3, and PR 4. These eight wires are terminated at a suitable connector such as the depicted RJ 45 connector 140. Connector 140 receives its eight signals from the eight signals 151-158 produced by MIFU 138. MIFU 138 generates signals 151-158 based upon the state of eight signals 141-148 (processor signals) produced by processor 130.

One embodiment of NIC 120 maintains a table 150 in RAM 132 that defines the correspondence between logical output pins and physical output pins of processor 130. Table 150 may also be implemented with a special or general purpose register. Processor 130 includes the ability to produce any possible correspondence between its logical pins such that any logical pins may be assigned to any physical pin. If NIC 120 determines that one or more signal wires in media 103 is non-functional, NIC 120 may reconfigure the logical to physical pin correspondence to re-route signals to a set of functional signal wires in media 103.

Portions of the invention may be implemented as a set of computer executable instructions (software). The software may be stored on a computer readable medium, including, in this example, ROS 134 and RAM 132 of NIC 120. ROS 134 may be implemented with a ROM, flash memory device, or any other suitable non-volatile storage device. RAM 132 is typically implemented with one or more DRAM modules.

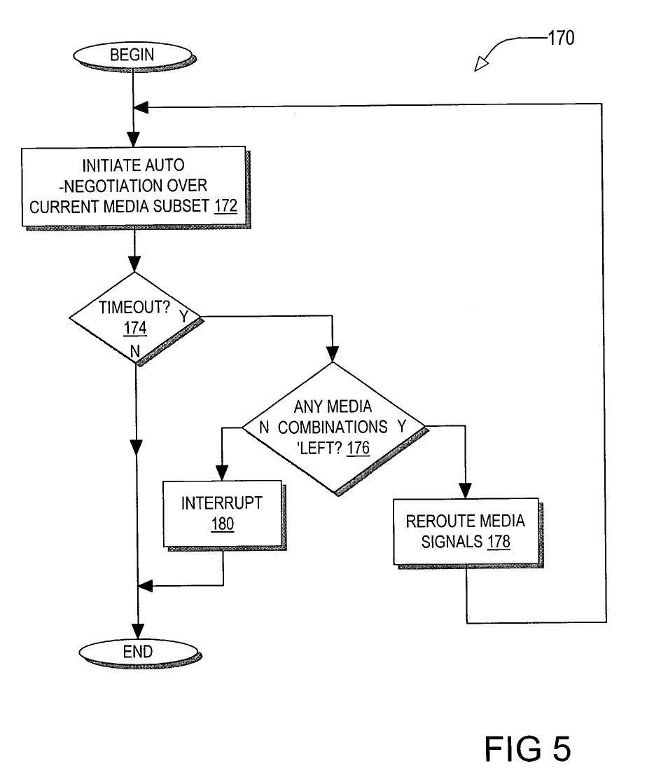

Referring now to FIG. 5, a flow diagram illustrating a method 170 of implementing a network media according to one embodiment of the invention is presented. Initially, an attempt to communicate between network devices is made by first sending some form of initialization sequence over the network media over an initial subset of wires within the media. In the depicted embodiment, the initialization sequence includes an Ethernet Auto-negotiation sequence as indicated in block 172.

Most 100 Mbps Ethernet adapters and all Ethernet Gig Adapters incorporate an Auto-negotiation feature that enables the adapter to communicate with slower (10 Mbps) adapters. Auto-negotiation is defined in Clause 28 of the 1998 edition of IEEE Standard (Std) 802.3. During an Ethernet Auto-negotiation sequence, two devices determine the highest level of service (including the data rate) at which both ends of the connection can operate. The levels of services are prioritized according to a predetermined definition. Initially, both ends of the connection configure themselves according to the lowest priority level of service (typically 10BaseT). The systems then attempt to negotiate for a mutually attainable higher level of service using the Auto-negotiation procedure.

One embodiment of the present invention leverages the Auto-negotiation functionality of the large installed base of Ethernet adapters to determine if network media 103 is fully functional. If media 103 is determined to be non-functional, the invention attempts to maintain network functionality by re-routing signals to a functional set of wires. More specifically, one embodiment of the invention relies on the Fast Link Pulse (FLP) generated by Ethernet adapters at the start of the Auto-negotiation process to verify the integrity of the media.

Fast Link Pulse (FLP) signals are a modified version of the Normal Link Pulse (NLP) signals used for verifying link integrity, as defined in the original 10BaseT specifications. FLP signals are generated automatically at power-up, or may be selected manually through a management interface to an Auto-negotiation device such as NIC 120. Like the original NLP, FLP signals take place during idle times on the network link and do not interfere with normal traffic. FLP signals are conventionally used to send information about device capabilities. The Auto-negotiation protocol contains rules for device configuration based on this information that enables the NICs 120 in switch 104 and device 102 to automatically negotiate and configure themselves to use the highest level of service.

Because Auto-negotiation was originally specified for 100 Mbps adapters that may have been installed on 2 pair cabling systems, the FLP signals are restricted to 2-pairs of wires even on systems (such as Gigabit systems) employing 4 pair cabling. If one of the four wires in the 2 pairs used to send the FLP signals is non-functional (open, shorted to ground, shorted to Vdd, and so forth), the Auto-negotiation will not complete successfully. To detect and respond to this condition, the depicted embodiment of the present invention monitors for a timeout condition (block 174) after initiating the Auto-negotiation sequence. If a time out is detected in block 174, it is assumed that one of the four original FLP wires is non-functional.

In response to a time out condition, the depicted embodiment of method 170 then sequences through the set of possible logical/physical pin permutations until a setting is detected that results in the successful transmission of the FLP signals. More specifically, upon detecting a timeout condition in block 174, method 170 then determines (block 176) whether all of the possible media configurations or subsets have been exhausted. If not, NIC 120 reroutes (block 178) its logical-to-physical pin assignments to the next logically sequential combination and re-initiates the Auto-negotiation process (block 178). If a timeout occurs using the newest combination, the next logically sequential combination is attempted and so forth until all combinations have been attempted. If all combinations of logical/physical pin assignments have used without successfully resulting in the transmission of an FLP, an interrupt is issued (block 180) and the process terminates with a fatal error condition. If a timeout does not occur, implying that the Auto-negotiation sequence completed successfully, the network link is established at the negotiated level of service using the physical signal wires that were determined to be functional. In this manner, the invention enables any connection employing 4-pair CAT 5 wiring to continue operation at speeds of up to 100 Mbps even if 50% of the media's signal wires are non-functional. This elegant solution thus provides a significant level of fault tolerance into the network at a minimal cost.

The process of using different logical/physical pin combinations as described above effectively re-routes the FLP signals onto different combinations of wires within media 103. If any four of the wires in media 103 are functional, the FLP handshake sequence will eventually complete normally. In one embodiment, the switch 104 is configured as the receiver of the FLP signals while the device 102 is the sender. Switch 104 may be configured to read all 8 wires. In a typical implementation, the wires in media 103 are tied to a voltage source (Vss or Vdd) through a high impedance element such as a suitable resistor. In such an implementation, an open or otherwise floating wire in media 103 will be tied to a static voltage level. Since the FLP signals “wiggle” each of the corresponding signal wires, it will be apparent to switch 104 which wire(s) are bad. Upon discovering 4 functional wires, the switch can re-route the 4 active bits onto the four functional wires. All subsequent packet transfers can then occur over the 4 functioning wires.

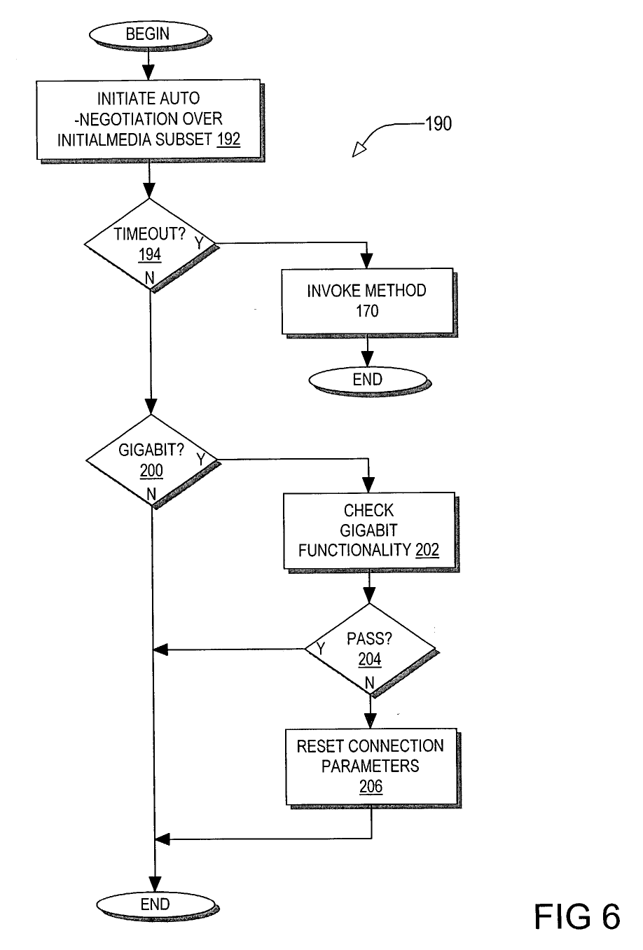

While the method 170 described above is effective in sustaining network functionality after an auto-negotiate failure, the present invention emphasizes a method of establishing and verifying network functionality when auto-negotiation passes. This process is important because auto-negotiate does not check functionality of the entire media and network errors may occur following a successful auto-negotiate. Referring now to FIG. 6, a method 190 depicted in flow diagram format illustrates a feature of the invention that extends the auto-negotiate to include a gigabit functionality verification.

Gigabit functionality method 190 as depicted in FIG. 6, begins by attempting to auto-negotiate (block 192) over an initial subset of network media wires. If auto-negotiate times out (block 194), the method 170 of FIG. 5 is invoked to determine if functionality at any level of service is possible using a different subset of the network media wires. If auto-negotiate fails on any subset of wires, gigabit functionality is not possible because gigabit Ethernet requires all media wires to be functional.

Assuming that auto-negotiate does not time out in block 194, it will determine a level of service for the connection based on the capabilities of the devices on each end of the connection. The gigabit functionality method 190 follows the successful completion of an auto-negotiation session by first querying (block 200) whether the level of service that was established is a gigabit level of service. If the established level of service does not require eight functional wires (i.e., is not gigabit), no further action is required. If the established level of service does, however, required eight functional wires, gigabit functionality method 190 according to the present invention takes additional action. Gigabit functionality is verified (block 202) following an auto-negotiate session that establishes a gigabit level of service.

The gigabit functionality determination, according to one embodiment, is made by sending a data stream over the connection that can only be verified if all eight wires in media 103 are functional. Although the specific data pattern that is sent is implementation specific, an alternating sequence of logical 1's and 0's (on all eight wires) is likely performed as part of the gigabit functionality determination. Alternating 1's and 0's is a useful verification data stream because it assures that all eight media signals can toggle thereby eliminating from gigabit consideration any implementations in which one or more of the signal wires is grounded, floating, cut, and so forth. Additional tests may be performed to rule out inter-signal shorting. The signal wires within each twisted-pair, for example, may transmit logically complementary versions of the alternating bit pattern.

If the gigabit functionality check passes (block 204), the procedure completes and the link is established at a gigabit level of service. If the gigabit functionality check fails, however, the level of service parameters are reset (block 206) to the highest level of service operable on less than eight wires. In a likely implementation, failure of the gigabit functionality verification will cause the system to reset the connection to a full duplex, 100BaseT level of service. In this manner, the gigabit verification extension of the auto negotiation procedure provides added assurance, reliability, and automation to the Ethernet environment without in a manner that is relatively transparent to the system. The functionality verification described herein implies no hardware changes to the existing base of Ethernet installations and can be readily implemented with a modest amount of additional software.

It will be apparent to those skilled in the art having the benefit of this disclosure that the present invention contemplates a method and system for establishing and verifying a high-speed network connection. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of determining a data rate between two devices connected via a network medium, comprising:
performing a negotiation process to determine the highest data rate sustainable by both of the devices, wherein the negotiation process uses only a portion of the signal wires in the network medium;
responsive to negotiating a final data rate, verifying the functionality of all the signal wires in the media between the two devices if the negotiated data rate is a data rate using all the signal wires;
responsive the functional verification of all the wires failing, selecting a data rate that is less than the negotiated final data rate as the final data rate for the connection.

2. The method of claim 1, wherein the media consists of 4 twisted-pairs of wires and wherein performing the negotiation process is further characterized as performing the negotiation process using two of the twisted pairs of wires.

3. The method of claim 1, wherein performing the negotiation process is further characterized as performing a negotiation process to select among a data rate of 10, 100, and 1000 Mbps.

4. The method of claim 3, wherein performing the functional verification is further characterized as performing the functional verification only if the negotiated data rate is 1000 Mbps.

5. The method of claim 4, wherein selecting the data rate that is less than the negotiated data rate comprises selecting the 100 Mbps data rate as the final data rate.

6. The method of claim 1, wherein performing the functional verification comprises transferring a pattern of 1's and 0's between the two devices on all of the signal wires.

7. The method of claim 6, wherein transferring a pattern of 1's and 0's comprises transferring a pattern of alternating 1's and 0's on each of the wires.

8. A data processing network, comprising:
a network media comprising eight signal wires;
first and second network devices, each having a network interface device connecting its corresponding device to the network media;
network interface device means for negotiating a data rate between the first and second network devices using a portion of the media signal wires and for verifying the functionality of all the signal wires.

9. The network of claim 8, wherein the media consists of 4 twisted-pairs of wires and wherein performing the negotiation process is further characterized as performing the negotiation process using two of the twisted pairs of wires.

10. The network of claim 8, wherein performing the negotiation process is further characterized as performing a negotiation process to select among a data rate of 10, 100, and 1000 Mbps.

11. The network of claim 10, wherein performing the functional verification is further characterized as performing the functional verification only if the negotiated data rate is 1000 Mbps.

12. The network of claim 11, wherein selecting the data rate that is less than the negotiated data rate comprises selecting the 100 Mbps data rate as the final data rate.

13. The network of claim 8, wherein performing the functional verification comprises transferring a pattern of 1's and 0's between the two devices on all of the signal wires.

14. The network of claim 13, wherein transferring a pattern of 1's and 0's comprises transferring a pattern of alternating 1's and 0's on each of the wires.

15. A network interface device suitable for connecting a network device to a network media consisting of four twisted pairs of wires, comprising:
negotiation means for automatically selecting a data rate for use between the network device and a second network device connected to the media;
verification means for verifying functionality of all of the wires in the signal, the verification means being responsive to the negotiation means selecting a data rate that uses all four of the twisted pairs of wires; and
the verification means being further configured to select a data rate of less than the negotiated data rate upon failing to verify functionality of all of the wires.

16. The network interface device of claim 15, wherein the negotiation means selects a data rate among a data rate of 10, 100, and 1000 Mbps.

17. The network interface device of claim 16, wherein the verification means performs the functional verification only if the negotiated data rate is 1000 Mbps.

18. The network interface device of claim 15, wherein the verification means is configured to detect a pattern of alternating 1's and 0's from the second device on all of the signal wires.

19. The network interface device of claim 15, further characterized as an Ethernet compatible network interface device.

20. The network interface device of claim 19, further characterized as a PAM 5 network interface device.
